(19) United States
(12) Patent Application Publication
(10) Pub. No.: US 2007/0006257 A1
(43) Pub. Date: Jan. 4, 2007

(54) Channel changing in a digital broadcast system

(76) Inventors: Jae-Jin Shin, Seoul (KR); Sung-Kwon Park, Seoul (KR); Hong-Ik Kim, Yongin-si (KR); Tae-Woong Kim, Goyang-si (KR); Su-Kyung Kim, Ansan-si (KR); Joon-Soon Im, Seongnam-si (KR)

Correspondence Address: Robert E. Bushnell, Suite 300, 1522 K Street, N.W., Washington, DC, 20005-1202, US

(21) Appl. No.: 11/397,565

(22) Filed: Apr. 5, 2006

(30) Foreign Application Priority Data
Jun. 30, 2005 (KR) 2005-58374

(51) Int. Cl. H04N 5/445

(52) U.S. Cl. 725/38

(57) ABSTRACT

A channel changing apparatus and method in a digital broadcasting system can reduce channel changing time by including a plurality of broadcast programs in one logical channel, and in response to channel changing, selectively displaying a corresponding program in the logical channel.

### CLAIM OF PRIORITY

This application makes reference to and claims all benefits accruing under 35 U.S.C. § 119 from an application for CHANNEL CHANGING APPARATUS AND METHOD IN A DIGITAL BROADCAST SYSTEM earlier filed in the Korean Intellectual Property Office on Jun. 30, 2005 and there duly assigned Ser. No. 10-2005-0058374.

### BACKGROUND OF THE INVENTION

1. Field of the Invention

The present invention relates to channel changing in a digital broadcasting system. More particularly, the present invention relates to a channel changing method and apparatus in a digital broadcasting system.

2. Description of the Related Art

A digital broadcasting system transmits contents data by compressing them according to channels in a high concentration based upon Moving Picture Experts Group (MPEG) coding standards and then multiplexing them corresponding to a number of channels based upon digital modulation according to transmitting media. Due to these characteristics, the digital broadcasting system can transmit tens or hundreds of channels unlike an analog broadcasting system. The digital broadcasting system can remarkably raise the efficiency of frequency availability over that of the analog broadcasting system. Through this, the digital broadcasting system can advantageously increase the number of broadcast channels. Besides, digital broadcasting system enables multiple utilization of softwares in specialized pay broadcasting and bidirectional service broadcasting, and thus achieve an opportunity that broadcasting industry can develop into multimedia industry. Owing to these reasons, the digital broadcasting system is being widened starting from satellite broadcasting up to cable and ground wave broadcasting, and highlighted as next generation broadcasting technologies.

However, the digital broadcasting system requires long channel changing (zapping) time owing to digital broadcast signal processing, digital contents protection and bidirectional application. This is not a frequent phenomenon in analog broadcasting, and thus gives inconvenience to digital broadcasting audience. It is known that digital cable broadcasting has particularly fragile channel changing properties in comparison with other broadcast media.

Factors that create long channel changing time in digital broadcasting may include tuning time especially for physical channels, conditional access confirmation for contents protection, decoding for logical channel discrimination and so on. So, digital broadcasting requires long channel changing time since such several procedures have to be carried out for broadcast receipt.

### SUMMARY OF THE INVENTION

The present invention has been made to solve the foregoing problems of the prior art and it is therefore an object of the present invention to provide a channel changing apparatus and method capable of reducing channel changing time in a digital broadcasting system.

According to an aspect of the present invention for realizing the above objects, a channel changing apparatus of a broadcast transmission system in a digital broadcasting system is provided, including a controller adapted to generate at least one piece of broadcast data including a plurality of programs and to transmit each of the generated broadcast data via each physical channel.

Preferably, the broadcast data can be high definition level data, and the programs are standard defining level data.

Preferably, the broadcast data can be generated so that programs of an equal policy are included in one broadcast data.

Preferably, the controller can receive program information from a broadcast receiving system, selected by a user of the broadcast receiving system, and generate the broadcast data so that programs selected based upon the program information are included in one broadcast data.

Preferably, the controller can transmit channel information as included in the broadcast data, the screen channel information being used for the selection of each program included in the broadcast data.

Preferably, the screen channel information can include at least Program Identifier (PIP) of each program included in the broadcast data.

Preferably, the controller can transmit screen channel information via a data transmission channel, the screen channel information being used for the selection of each program included in the broadcast data.

Preferably, the controller can generate the broadcast data so that all of the programs included in the broadcast data are displayed on a single screen.

Preferably, the controller can divide the single screen by the number of the programs included in the broadcast data, and display each of the programs allocated to each of divided areas of the single screen.

According to another aspect of the present invention for realizing the above objects, a channel changing apparatus of a broadcast receiving system in a digital broadcasting system is provided, including a controller adapted to receive broadcast data including a plurality of programs from a broadcast transmission system, the broadcast data being received via a logical channel, and to selectively output one of the programs of the broadcast data corresponding to a request channel inputted by a user.

Preferably, the controller can, upon receiving the request channel, confirm a program corresponding to the request channel based upon screen channel information in use for the selection of each program, and output the program.

Preferably, the controller can receive the screen channel information via the logical channel for the transmission of the broadcast data.

Preferably, the controller can receive the screen channel information via a data transmission channel separate from the logical channel for the transmission of the broadcast channel.

Preferably, the controller can, upon receiving a user request for information on programs to be provided, display at least one of the programs of the received broadcast data.

Preferably, the controller can divide a display screen by the number of the programs included in the broadcast data, and display each of the programs allocated to each of divided areas of the display screen.

Preferably, the controller can output screen channel information used for the selection of each program on a screen used for the display of the programs, in an On Screen Display (OSD) format.

According to still another aspect of the present invention for realizing the above objects, a channel changing apparatus in a digital broadcasting system is provided, including: a broadcast transmission system adapted to generate broadcast data including a plurality of programs, and to transmit the generated broadcast data included in a logical channel; and a broadcast receiving system adapted to receive the broadcast data from the broadcast transmission system, and to output any of the programs of the broadcast data corresponding to a request channel of a user.

According to yet another aspect of the present invention for realizing the above objects, a channel changing method of a broadcast transmission system in a digital broadcasting system is provided, including: generating broadcast data including a plurality of programs to be transmitted via a logical channel; and transmitting the generated broadcast data included in the logical channel.

According to still another aspect of the present invention for realizing the above objects, a channel changing method of a broadcast receiving system in a digital broadcasting system is provided, the method including: receiving broadcast data including a plurality of programs from a logical channel; receiving a channel changing request from a user; selecting a program from the programs of the received broadcast data corresponding to a changing-requested channel; and outputting the selected program.

As described above, the channel changing apparatus in the digital broadcasting system of the present invention to be described hereunder has technical features including reducing channel changing time in digital broadcasting by including a plurality of broadcast programs in one logical channel, and in response to channel changing, selectively displaying a corresponding program in the logical channel. That is, the present invention can reduce channel changing time in digital broadcasting by reducing time consumption created by decoding for logical channel changing or tuning for physical channel changing.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of a digital broadcast transmission system for executing channel changing in accordance with an embodiment of the present invention;

FIG. 2 is a block diagram of a digital broadcast receiving system for executing channel changing in accordance with an embodiment of the present invention;

FIG. 3A is a diagram of a plurality of programs included in one broadcast program, all of which are displayed on a single screen;

FIG. 3B is a diagram of some of the programs included in one broadcast program, which are displayed on a single screen;

FIG. 3C is a diagram of a plurality of programs included in one broadcast program, all of which are displayed together with their screen channel information on a single screen;

FIG. 4 is a flowchart of channel changing in a digital broadcast transmission system according to an embodiment of the present invention; and

FIG. 5 is a flowchart of channel changing in a digital broadcast receiving system according to an embodiment of the present invention.

### DETAILED DESCRIPTION OF THE INVENTION

Channel changing in accordance with an embodiment of the present invention can be divided into two categories. A first category is channel changing to a selected program in a logical channel, and second category is channel changing to a selected logical or physical channel. The present invention is directed to channel changing of the first category, that is, channel changing to a selected program in a logical channel. Strictly speaking, selected program changing in a logical channel does not mean any changing in “channels”. However, a user who requests channel changing recognizes selected program changing as channel changing. Thus, herein program changing in a logical channel according to the invention will be also referred to as “channel changing” without any specific comment. The invention adopts a conventional process for logical or physical channel changing, and thus additional explanation will not be given on logical or physical channel changing.

The following description will present broadcast data used in the present invention, a channel changing apparatus used, and a channel changing method for changing channels according to the present invention.

The term “broadcast data” used in the present invention is data including a plurality of programs, transmitted via a logical channel. In the following description, the generation of broadcast data is described with a specific example.

In general, the present invention generates broadcast data in such a fashion that a plurality of programs of a relatively low definition are displayed on a high definition screen. A high definition screen has a larger number of pixels than a low definition screen, and thus can be divided into pieces to display a plurality of low definition screens. A high definition digital broadcast needs a large transmission capacity, with a broadcast screen having a large number of horizontal and vertical pixels. In comparison, a low definition digital broadcast needs a small transmission capacity, with a broadcast screen having a small number of horizontal and vertical pixels.

Digital broadcasts are currently transmitted on the basis of MPEG-2 standards that provide various screen qualities, in which the definition of a digital broadcast is determined by an MPEG-2 level and profile.

Table 1 below includes examples of MPEG-2 levels and profiles. The generation of broadcast data according to the present invention is described hereunder with reference to Table

TABLE 1

| | | H. size | V. size | Frame rate | Bit rate | VBV size |
|---|---|---|---|---|---|---|
| Profile | Level | (pels) | (pels) | (Hz) | (Mbps) | (Mbits) |
| Simple | Main | 720 | 576 | 30 | 15 | 1.835 |
| Main | Low | 352 | 288 | 30 | 4 | 0.489 |
| | Main | 720 | 576 | 30 | 15 | 1.835 |
| | High | 1440 | 1152 | 60 | 60 | 7.340 |
| | 1440 | | | | | |
| | High | 1920 | 1152 | 60 | 80 | 9.787 |
| SNR | Low | 352 | 288 | 30 | 3 | 0.367 |
| Scalable | | | | | (4) | (0.487) |
| | Main | 720 | 576 | 30 | 10 | 1.223 |
| | | | | | (15) | (1.835) |
| Spatially | High | 720 | 576 | 30 | 15 | 1.835 |
| Scalable | 1440 | (1440) | (1152) | (60) | (40) | (4.893) |
| | | | | | (60) | (7.340) |
| High | Main | 352 | 288 | 30 | 4 | 0.489 |
| | | (720) | (576) | (30) | (15) | (1.835) |
| | | | | | (20) | (2.447) |
| | High | 720 | 576 | 30 | 20 | 2.447 |
| | 1440 | (1440) | (1152) | (60) | (60) | (7.340) |
| | | | | | (80) | (9.786) |
| | High | 960 | 576 | 30 | 25 | |
| | | (1960) | (1152) | (60) | (80) | |
| | | | | | (100) | |

A description follows on an exemplary situation, in which a plurality of programs having a Standard Definition (SD) level are displayed on a single screen of a High Definition (HD) level. SD level definition is produced according to a coding technique that is called MP@ML in MPEG-2, which is typically used for digital broadcasting in Korea.

As in Table 1 above, the number of bound pixels supported by SD level digital broadcasting is half or less than that supported by HD (MP@HL) level digital broadcasting. A transmission capacity of about 2 Mbps is required to transmit HD level digital broadcasts in comparison with a transmission capacity of about 4 Mbps to transmit SD level digital broadcasts. Considering such transmission capacity and supportable pixels, about 4 SD level programs can be transmitted through one HD level broadcast channel. That is, one HD level broadcast data can include 4 SD programs.

Transmitting 4 SD screens in one HD screen requires a short channel changing time between 4 SD broadcasts in the HD screen since SD program changing in an HD digital broadcast does not require logical channel changing. That is, SD program changing does not require tuning, CAS control, decoding and the like.

It is possible to further increase the number of broadcast programs included in one broadcast data by changing the transmission capacity of one logical channel and the compressibility of programs to be transmitted.

A description follows of a channel changing apparatus in accordance with an embodiment of the present invention that uses the afore-mentioned broadcast data in channel changing.

The channel changing apparatus in a digital broadcasting system according to the an embodiment of the present invention can be considered in both aspects of a broadcast transmission system and a broadcast receiving system in a digital broadcasting system. In order to realize the present invention, a broadcast transmission system has to be able to transmit a plurality of programs via one logical channel and a broadcast receiving system has to be able to selectively output one from the programs, corresponding to a channel-changing request by a user. Hereinafter, the channel changing apparatus in a digital broadcasting system of an embodiment of the present invention is described in the aspects of the broadcast transmission system and the broadcast receiving system. The system to which the present invention is applied will be regarded as a digital cable broadcast system hereunder.

The channel changing apparatus of the broadcast transmission system is described first. The digital broadcast transmission system will be assumed to be a head-end.

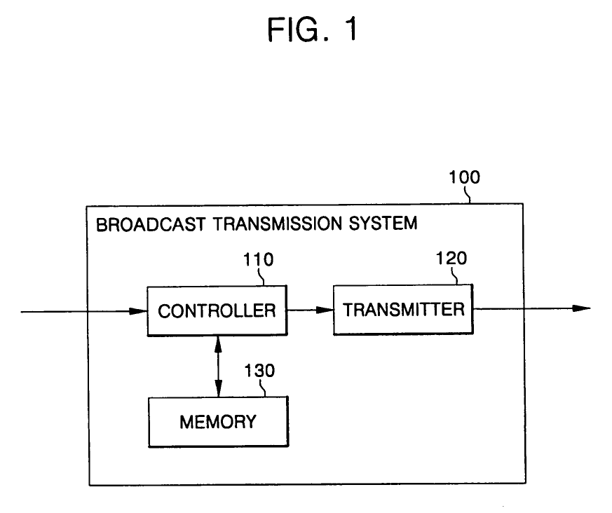

FIG. 1 is a block diagram of a digital broadcast transmission system for executing channel changing in accordance with an embodiment of the present invention.

As shown in FIG. 1, a digital broadcast transmission system 100 includes a controller 110, a transmitter 120 and a memory 130.

The controller 110 of the digital broadcast transmission system 100 generates broadcast data including a plurality of programs by combining a plurality of low definition (e.g., SD level) digital broadcast screens into one High Definition (HD) digital broadcast screen. The controller 110 can combine the broadcast data by dividing the screen into a plurality of areas corresponding to the number of programs included in the broadcast data and respectively allocating each program to a divided area.

The controller 110 can also generate low definition digital broadcast information, that is, “screen channel information” on the high definition digital broadcast screen. The controller 110 transmits generated screen channel information in several techniques: transmitting screen channel information as included in broadcast data; transmitting screen channel information via a logical channel being used for the transmission of broadcast data; and transmitting screen channel information via a separate data transmission channel other than the logical channel being used for the transmission of broadcast data. The transmission of screen channel information via a separate data transmission channel can be used particularly in an Out Of Band (OOB) system. The screen channel information transmission techniques can be selected according to system properties. Tables 2 and 3 below indicate examples of screen channel information.

TABLE 2

| | | | |
|---|---|---|---|
| Ch 101 | Ch 102 | Ch 103 | Ch 104 |
| Ch 105 | Ch 106 | Ch 107 | Ch 108 |
| Ch 109 | Ch 110 | Ch 111 | Ch 112 |
| Ch 113 | Ch 114 | Ch 115 | Ch 116 |

TABLE 3

| | | | | | | Section 16 |
|---|---|---|---|---|---|---|
| | | | Section 2 | Section 3 | | x: 3n + |
| | | Section 1 | x: n + | x: 2n + | | 1˜4n |
| | | x: 0˜n | 1˜2n | 1˜3n | | y: 3m + |
| Video Information | | y: 0˜m | y: 0˜m | y: 0˜m | . . . | 1˜4m |
| Logical | Channel | Ch 101 | Ch 102 | Ch 103 | . . . | Ch 116 |
| Channel 1 | PID | 201 | 202 | 203 | . . . | 216 |
| Logical | Channel | Ch 117 | Ch 118 | Ch 119 | . . . | Ch 132 |
| Channel 2 | PID | 217 | 208 | 219 | . . . | 232 |
| . . . | . . . | . . . | . . . | . . . | . . . | . . . |
| | . . . | . . . | . . . | . . . | . . . | . . . |

Table 3 in particular includes screen channel information containing division area information. In Table 3, x indicates horizontal pixel coordinate information and y indicates vertical pixel coordinate information. A Program Identifier (PID) is an identifier used for identifying programs. Screen channel information can include various items other than those reported above.

The controller, when generating broadcast data including a plurality of programs, can set programs of the same policy (e.g., price policy, conditional access policy and broadcaster's transmission policy) to be included in one broadcast data. Including programs of the same policy in one piece of broadcast data can facilitate CAS control.

Furthermore, the controller 110 can set adjacent programs to be included in one piece of broadcast data, when generating broadcast data including a plurality of programs. In general, a user often selects adjacent programs, and thus including adjacent programs in one piece of broadcast data can further raise the efficiency of the invention.

Moreover, the controller 110 can transmit programs requested by a specific broadcast receiving system, as being included in one piece of broadcast data. The requested programs can be “preference programs” that users select, “interested programs” that users have set and so on. Broadcast data can be generated in view of specific user convenience as above since a digital broadcasting system can provide a number of channels. However, the number of channels available in the digital broadcasting system is also limited. Thus, it can be preferably focused selectively to premium users.

The transmitter 120 serves to transmit broadcast data including a plurality of broadcast programs from the controller 110 to a broadcast receiving system. The transmitter 120 can convert transmitting data into a format defined according to the properties of transmission media used in transmission. Examples of the transmission media can include electrical waves and transmission lines. Since it is assumed that the present invention is applicable to a digital cable broadcasting system, transmission lines can be used as transmission media.

The memory 130 serves to store information, such as screen channel information, that is used in the realization of the present invention.

A description follows on a channel changing apparatus of a broadcast receiving system. The broadcast receiving system will be assumed hereunder to be a Set-Top Box (STB). The channel changing apparatus of a broadcast receiving system of the present invention has to be able to receive broadcast data from a broadcast transmission system and output a program selected by a user from the programs in the broadcast data.

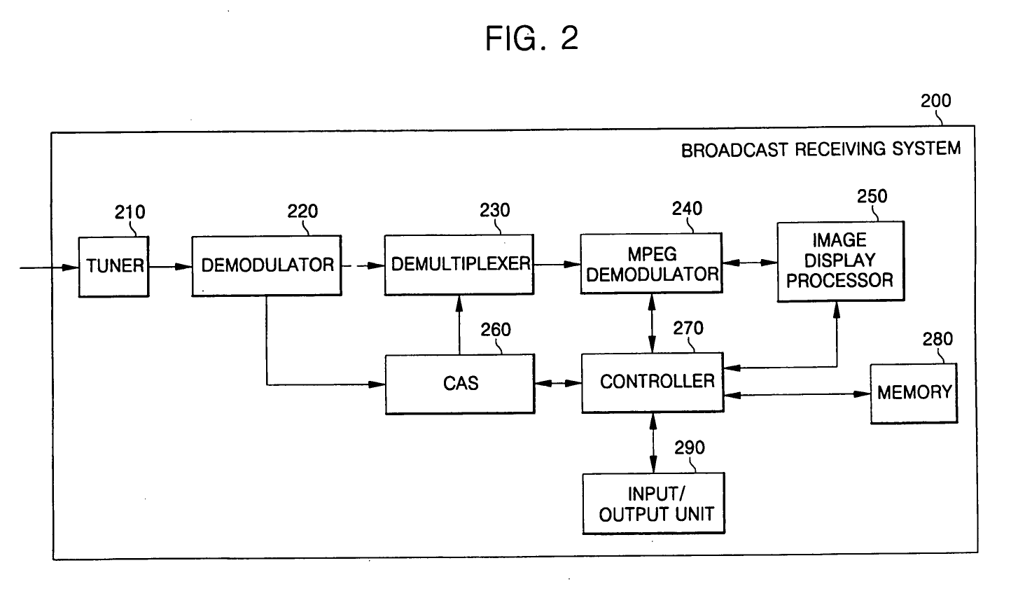

FIG. 2 is a block diagram of a digital broadcast receiving system for executing channel changing in accordance with an embodiment of the present invention.

As shown in FIG. 2, a digital broadcast receiving system 200 includes a tuner 210, a demodulator 220, a demultiplexer 230, an MPEG demodulator 240, an image display processor 250, a Conditional Access System (CAS) 260, a controller 270, a memory 280 and an input/output unit 290.

The tuner 210 of the digital broadcast receiving apparatus 200 executes tuning to discriminate a desired physical channel from an analog broadcast signal received from the digital broadcast transmission system 100. The demodulator 220 demodulates the analog signal from the tuner 210 into a digital signal. The demodulator 220 also outputs conditional access related data such as key information and program watching authority information to the CAS 260. The demultiplexer 220 demultiplexes physical channels to separate logical channels from the physical channels. The MPEG demodulator 240 decompresses MPEG data included in the physical channels that are outputted from the demultiplexer 230. The above-mentioned components such as the tuner 210 to the MPEG demodulator 240 can be referred to as a receiver.

The image display processor 250 executes image processing to provide broadcast data including a plurality of programs received from the MPEG demodulator 240 to a user by outputting the broadcast data via a display unit. The image display unit 250 can display the programs on a single screen or one selected program on a screen. If all of the programs included in the broadcast data are displayed on the single screen, the user can easily select a channel to watch. The image display processor 250 is controlled by the controller 270.

The CAS 260, when a subscriber or user selects a program, confirms whether or not the subscriber has an authority to watch the selected program based upon watching authority information on programs, and if the subscriber has the authority, descrambles encoded program data according to key information.

The controller 270 interfaces with the above-mentioned components, and upon receiving a channel changing request from a user, selects a program corresponding to the user request from the programs included in the received broadcast data, and controls the image display processor 250 to output the selected program. For the purpose of program selection in response to the channel changing request by the user, the controller 270 can use screen channel information received from the broadcast transmission system 100. In addition, the controller 270 can request the broadcast transmission system 100 to transmit broadcast data including programs corresponding to a preference or interested channel of the user. For this purpose, the controller 270 can write selector channel information of the user by managing channel selection history of the user or let the user input interested channel information.

The memory 280 can store screen channel information received from the broadcast transmission system 100 and preference or interested channel information received from the controller 270. The input/output unit 290 executes input/output to/from the user.

Furthermore, it is possible to use various means for inputting user requests to the broadcast receiving system 200. Examples thereof can include function keys provided on the broadcast receiving system 200 or a remote control for operating the broadcast receiving system 200. Besides, various display means, such as a TV and monitor, can be used to display selected screens to a user.

When the channel changing request by a user is judged to be a request for a program included in broadcast data other than that being currently provided, the controller 270 executes channel changing to meet the request in the same fashion as in conventional channel changing.

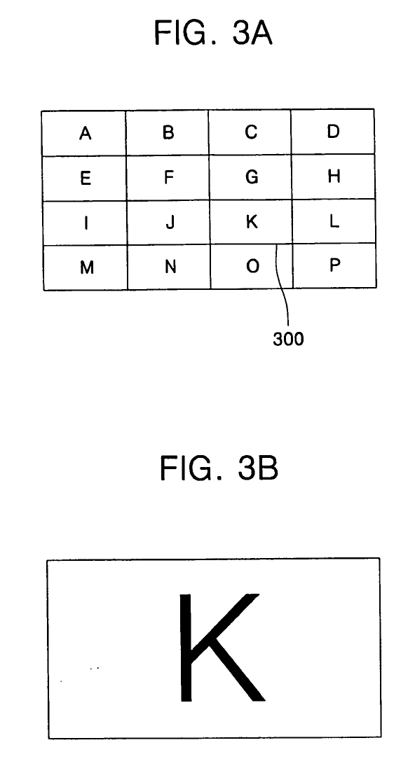

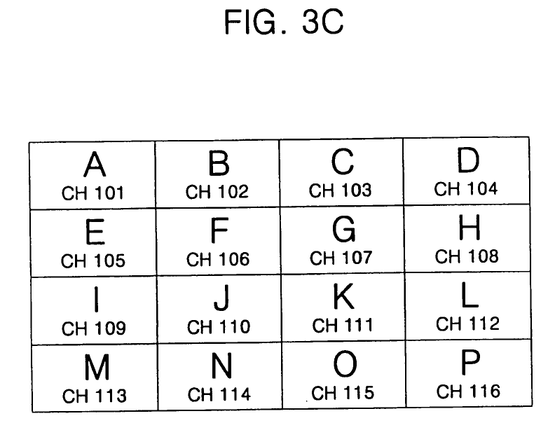

FIGS. 3A to 3C are diagrams of display formats of programs included in broadcast data according to the present invention, in which FIG. 3A is a diagram of a plurality of programs included in one piece of broadcast program, all of which are displayed on a single screen, FIG. 3B is a diagram of some of programs included in one broadcast program, which are displayed on a single screen, and FIG. 3C is a diagram of a plurality of programs included in one piece of broadcast program, all of which are displayed together with their screen channel information on a single screen.

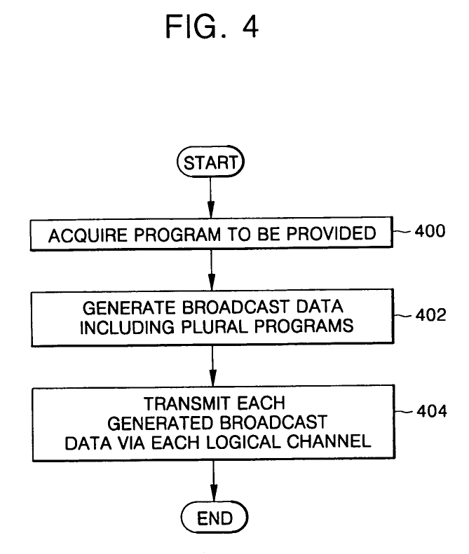

A channel changing method in accordance with an embodiment of the present invention is described below with reference to FIG. 4.

FIG. 4 is a flowchart of a channel changing process of a digital broadcast transmission system according to the present invention.

FIG. 4 only illustrates the generation and transmission of broadcast data in the digital broadcast transmission system 100 of the present invention, without illustrating the generation and transmission of screen channel information. The generation and transmission of screen channel information has been already described with reference to FIG. 1, and thus will not described hereunder.

In step 400, the channel changing apparatus acquires programs to be provided to the digital broadcast receiving system 200. The programs acquiring by the channel changing apparatus will not be described.

In step 402, the channel changing apparatus generates at least one piece of broadcast data including some of the programs acquired in step 400. The programs included by each piece of broadcast data generated in step 402 are selected from those acquired by the channel changing apparatus based upon separate references. The selection references of the programs to be included in each broadcast data may include various items, such as programs of the same policy, adjacent programs, a user preference or interested channel, in response to the request from the broadcast receiving system 200. It is possible to use some references from the above described various program selection references, considering the properties of the system or its service. Such references can be applied independently or at least two of them can be combined in one application.

In step 404, the channel changing apparatus transmits each of the at least one piece of broadcast data generated in step 402 to the broadcast receiving system 200 via each logical channel.

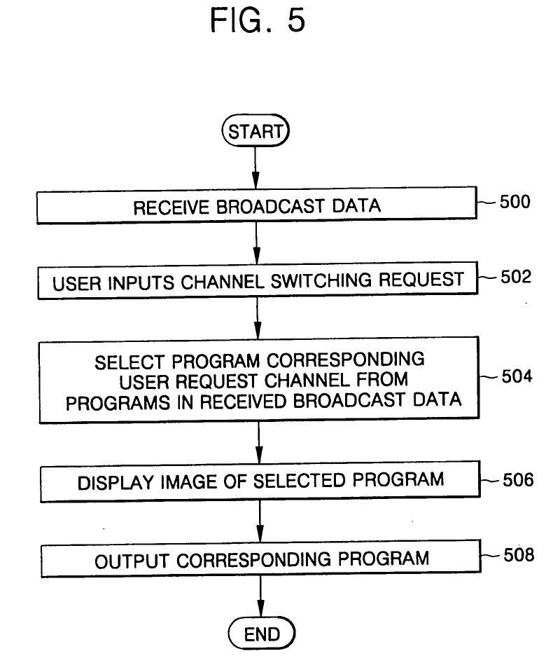

FIG. 5 is a flowchart of a channel changing process of a digital broadcast receiving system according to an embodiment of the present invention.

FIG. 5 only illustrates channel changing using received broadcast data in the digital broadcast receiving system 200 of the present invention, without illustrating the receipt of screen channel information. The receipt of screen channel information has already been described with reference to FIG. 2, and thus will not be described hereunder.

In S500, the channel changing apparatus receives broadcast data including a plurality of programs from the digital broadcast transmission system 100. Each piece of broadcast data is received via one logical channel. Thus, in order to receive one piece of broadcast data, it is necessary to tune a physical channel including a corresponding logical channel, and to decode the logical channel from the tuned physical channel. Such physical channel tuning and logical channel decoding can be executed in the same fashion as in conventional tuning and decoding. Once the programs included in the broadcast data received via one logical channel have been received by the digital broadcast transmission system 100 through tuning and decoding, they can be switched in response to a user request without separate tuning or decoding.

In step 502, the channel changing apparatus receives a channel-changing request inputted by the user. The channel changing request can be inputted into the channel changing apparatus via various input means that can include but is not limited to function keys provided in the digital broadcast receiving system 200 and a remote control for controlling the digital broadcast receiving system 200. The channel changing apparatus can allow a user to examine all of the programs in the currently provided broadcast data at the same time in order to assist the user in program selection. For this purpose, the channel changing apparatus can display all of the programs in the broadcast data on a single screen. In addition, the channel changing apparatus can display some or all of the items of screen channel information on a screen together with all of the programs in the broadcast data. The channel changing apparatus can output screen channel information in an OSD format.

In step 504, the channel changing apparatus selects a program corresponding to the user request channel in step 502 from the programs included in the broadcast data received in step 500. Program selection in step 504 can be executed according to screen channel information.

In step 506, the channel changing apparatus displays images of the selected program. That is, the channel changing apparatus executes image processing so that only the selected one of the programs included in the received broadcast data can be displayed on the entire screen. For this purpose, the channel changing apparatus selects only an area to which the selected program is allocated from divided areas of the single screen and executes image processing so that the selected area only can be displayed on the entire screen.

In step 508, the channel changing apparatus outputs the program to the user via the display means.

With the above-described process, it is possible to execute channel changing with respect to programs in one piece of broadcast data requested by a user in a reduced time period, which is obtained by omitting a time interval necessary for physical channel tuning or logical channel decoding from conventional channel changing time period.

Of course, when a user requested program is included in broadcast data other than the currently provided broadcast data, conventional physical channel changing or logical channel changing is required. However, program changing in the same broadcast data can be increased with reduced physical channel or logical channel changing according to types of programs included in broadcast data.

As described hereinbefore, selection references on programs included in broadcast data can include various items such as programs of the same policy, adjacent programs and a preference or interested channel. Of these references, the program selection according to a preference or interested channel is requested by the broadcast receiving system 200 to the broadcast transmission system 100. However, the program selection will not be described further since it has been described before.

Furthermore, in an application of the invention, the number of programs included in broadcast data that can be transmitted via one logical channel can be varied according to encoding techniques, compression techniques and so on. The efficiency of the channel changing according to the present invention can rise in proportion to the number of programs included in one piece of broadcast data.

As described hereinbefore, by applying the present invention which provides broadcast data including a plurality of programs via one logical channel, it is possible to reduce channel-changing time in the digital broadcasting system.

While the present invention has been shown and described in connection with the exemplary embodiments, it will be apparent to those skilled in the art that modifications and variations can be made without departing from the spirit and scope of the present invention as defined by the appended claims.

What is claimed is:

1. A channel changing apparatus of a broadcast transmission system in a digital broadcasting system, comprising: a controller adapted to generate at least one piece of broadcast data including a plurality of programs; and to transmit each generated piece of broadcast data via each physical channel.

2. The channel changing apparatus according to claim 1, wherein the broadcast data comprises high definition level data, and wherein the programs comprise standard defining level data.

3. The channel changing apparatus according to claim 1, wherein the broadcast data is generated so that programs of an equal policy are included in one piece of broadcast data.

4. The channel changing apparatus according to claim 1, wherein the controller is adapted to receive program information from a broadcast receiving system, selected by a user of the broadcast receiving system, and to generate the broadcast data so that programs selected based upon the program information are included in one piece of broadcast data.

5. The channel changing apparatus according to claim 1, wherein the controller is adapted to transmit channel information as included in the broadcast data, the screen channel information being in use for the selection of each program included in the broadcast data.

6. The channel changing apparatus according to claim 5, wherein the screen channel information includes at least a Program Identifier (PID) of each program included in the broadcast data.

7. The channel changing apparatus according to claim 1, wherein the controller is adapted to transmit screen channel information via a data transmission channel, the screen channel information being used for the selection of each program included in the broadcast data.

8. The channel changing apparatus according to claim 1, wherein the controller is adapted to generate the broadcast data so that all of the programs included therein are displayed on a single screen.

9. The channel changing apparatus according to claim 8, wherein the controller is adapted to divide the single screen by the number of the programs included in the broadcast data, and to display each of the programs allocated to each of divided areas of the single screen.

10. A channel changing apparatus of a broadcast receiving system in a digital broadcasting system, comprising: a controller adapted to receive broadcast data including a plurality of programs from a broadcast transmission system, the broadcast data being received via a logical channel; and to selectively output one of the programs of the broadcast data corresponding to a request channel inputted by a user.

11. The channel changing apparatus according to claim 10, wherein the controller is adapted to, upon receiving the request channel, confirm a program corresponding to the request channel based upon screen channel information used for the selection of each program, and to output the program.

12. The channel changing apparatus according to claim 11, wherein the controller is adapted to receive the screen channel information via the logical channel for the transmission of the broadcast data.

13. The channel changing apparatus according to claim 11, wherein the controller is adapted to receive the screen channel information via a data transmission channel separate from the logical channel for the transmission of the broadcast channel.

14. The channel changing apparatus according to claim 10, wherein the controller is adapted to, upon receiving a user request for information on programs to be provided, display at least one of the programs of the received broadcast data.

15. The channel changing apparatus according to claim 14, wherein the controller is adapted to divide a display screen by the number of the programs included in the broadcast data, and to display each of the programs allocated to each of divided areas of the display screen.

16. The channel changing apparatus according to claim 14, wherein the controller is adapted to output screen channel information used for the selection of each program on a screen used for the display of the programs, in an On Screen Display (OSD) format.

17. A channel changing apparatus in a digital broadcasting system, comprising:
a broadcast transmission system adapted to generate broadcast data including a plurality of programs, and to transmit the generated broadcast data included in a logical channel; and
a broadcast receiving system adapted to receive the broadcast data from the broadcast transmission system, and to output any of the programs of the broadcast data corresponding to a request channel of a user.

18. The channel changing apparatus according to claim 17, wherein the broadcast transmission system is adapted to generate and transmit broadcast data including programs requested by the broadcast receiving system.

19. A method of changing channels in a broadcast transmission system of a digital broadcasting system, the method comprising:
generating broadcast data including a plurality of programs to be transmitted via a logical channel; and
transmitting the generated broadcast data included in the logical channel.

20. The method of changing channels according to claim 19, wherein the programs of the broadcast data have an equal policy.

21. The method of changing channels according to claim 19, wherein the programs of the broadcast data are received from a broadcast receiving system, as selected by a user of the broadcast receiving system.

22. The method of changing channels according to claim 19, further comprising: generating and transmitting screen channel information used for the selection of each program included in the broadcast data.

23. A method of changing channels of a broadcast receiving system in a digital broadcasting system, the method comprising:
receiving broadcast data including a plurality of programs from a logical channel;
receiving a channel-changing request from a user;
selecting a program from the programs of the received broadcast data corresponding to a changing-requested channel; and
outputting the selected program.

24. The method of changing channels according to claim 23, wherein selecting a program from the programs of the received broadcast data corresponding to a changing-requested channel is carried out based upon screen channel information for the selection of each program.
